(19) United States
(12) Patent Application Publication
(10) Pub. No.: US 2015/0245730 A1
(43) Pub. Date: Sep. 3, 2015

(54) Apparatus for converting an empty food can into a pressure cooker, a container for steam pressure, or a boiler

(71) Applicant: Bennett Scott Mills, Los Angeles, CA (US)

(72) Inventor: Bennett Scott Mills, Los Angeles, CA (US)

(21) Appl. No.: 14/194,694

(22) Filed: Mar. 1, 2014

(51) Int. Cl. A47J 27/08; A47J 27/04; B65D 25/28

(52) U.S. Cl. CPC A47J 27/08; B65D 25/2867; A47J 27/04; B65D 2525/283; A47J 2027/043

(57) ABSTRACT

An apparatus for converting an empty food can into a pressure cooker, a container for steam pressure, or a boiler comprised of an apparatus base (10), sealing lid (20) with an internally threaded orifice (80) for a device that either releases or regulates steam pressure, a plurality of connecting rods (30) and typical fasteners (40), (42), when assembled with a proper sized food can, shall achieve an airtight seal on the opening of the food can and when placed on or above a heat source of such significance as to bring the contents of the food can to a boil shall allow the generation of steam pressure.

### CROSS REFERENCE

None.

### FEDERALLY SPONSORED RESEARCH OR DEVELOPMENT

None.

### BACKGROUND

### Prior Art

The following is a tabulation of some prior art that presently appears relevant:

| U.S. Pat. No. | Kind Code | Issue Date |
|---|---|---|
| D544, 296 | (D) Design | Jun. 12, 2007 |

This invention is an apparatus that converts an empty food can into a pressure cooker, a container for steam pressure, or a boiler. Many survival training programs teach students to utilize an empty food can to purify water and prepare food for consumption. At or around fifteen years of age the inventor completed a three week survival training program. As an adult, the inventor endured a period of homelessness. During this period of homelessness, the inventor utilized his training to prepare food, primarily beans, with a large empty food can. The inventor encountered difficulties while homeless in Los Angeles, California in his efforts to prepare food with an empty food can, specifically;
a. A lack of an abundance of fuel on the ground, specifically wood, to create fire to cook food;
b. A means of covering the food can while cooking food, specifically a metal lid, could not be located at any consumer retail business;
c. The inventor primarily cooked beans using empty food cans; however, efforts to cover the food can while cooking rice with cardboard, scrap lumber, scrap metal sheeting, plastic material, failed to be effective. The effect was improperly cooked rice.

The inventor enrolled at a community college's two-year machinist certification program in Los Angeles, Calif. in the fall of 2010 at Los Angeles Trade Technical College. The inventor was able to complete all coursework of the spring 2010 semester approximately ten days before the final day of the semester. The inventor proposed creating a metal lid for the use of cooking with a large empty food can to Professor Peter Rauterkus, Professor of Manufacturing Technology. Upon approval the inventor spent the remainder of the spring 2010 semester fabricating an aluminum ringed lid with a glass cover inserted in the middle of the aluminum ring. The lid fits and slides down around the outside of the empty food can.

The inventor experimented with the aluminum ringed lid and eventually came to a realization that this design was not practical for the following reasons;
a. Boiling fluid tends to burst out of the space between the glass cover insert and the aluminum ring which in effect spews forth fluid onto surrounding surfaces;
b. Water is forced out of the space between the ring and the can, allowing water to dribble down the can. Water drips off the bottom of the can onto the surface of the cooking utility such a typical kitchen stove.

During the patent search process, conducted at the regional United States Patent and Trademark Office Depository located at the Burton Barr library in Los Angeles, California, the inventor was able to locate patent number D544, 296 dated Jun. 12, 2007. This patent is an ornamental design for a lid that so impressed the inventor into believing no other improvement could be made as to provide a means for simply covering a food can while cooking food. However, the inventor realized the solution to the problems encountered with fuel while homeless required a new approach to cooking with an empty food can. The inventor has decided to incorporate some of the superior design elements of design patent number D544296 into the sealing lid for the inventors design of the apparatus for converting an empty food can into a pressure cooker, a container for steam, or a boiler.

Domestically displaced individuals and families often scavenge thru the local environment in search of water, food, and other such basic necessities of survival. In an emergency or disaster situation, people shall scavenge thru the territory for wood and other fuels to create fire for the purpose of purifying water and cooking food. The greater the numbers of emergency and disaster victims, the greater the competition for such resources. Outdoor recreation enthusiasts such as campers, hunters, fisherman, and sailors are constantly seeking more efficient ways of preparing water and food for consumption. Pressure cookers significantly reduce the amount of fuel and time necessary to purify water and prepare food. First aid requires sterile instruments and the apparatus provides the ability to convert an empty food can into a steam container for the purposes of autoclaving. The steam pressure created by the apparatus is a potential source of energy that can be harvested for applications such as steam power generation for mechanical conversion.

Because the apparatus base makes direct contact with heat sources, the apparatus base should ideally be fabricated out of heavier metals, such as cast iron or plain carbon steel or stainless steel alloy; however, the inventor speculates that other metals, such as titanium alloys for example, may be desirable to special interest. The advantage of cast iron or plain carbon steels is that the heavier weight of cast iron or plain carbon steels should ad stability to the apparatus when in proper use helping to keep the apparatus from tipping over. The shape of the apparatus base is a round ring with walls of sufficient length and thickness to provide the structural support necessary for the purpose of converting an empty food can in to a pressure cooker, a container for steam pressure, or a boiler. The apparatus base contains a plurality of vertical thru connecting rod holes that are unthreaded for the connecting rods to go thru. In addition to the connecting rod holes, the apparatus base contains at least two vertically thru mounting holes for the purpose of mounting the apparatus base to whatever cooking surface or structure the apparatus is placed on when in use by utilizing appropriate fastening hardware such as a stove in a boat galley. The inside wall of the base acts as a sleeve for the bottom of the food can to fit into. At the bottom of the inside wall of the apparatus base is a protruding lip of sufficient length and thickness that stops the bottom of the food can from sliding out of the bottom of the apparatus base.

The apparatus sealing lid should ideally be fabricated out of stainless steel food grade alloy. The shape of the apparatus sealing lid is round and has an outer diameter that matches the outer diameter of the apparatus base. The apparatus sealing lid contains a plurality of unthreaded vertical thru apparatus connecting rod holes. The apparatus connecting rod hole-pattern in the sealing lid matches the apparatus connecting rod hole-pattern in the apparatus base. This serves the purpose of sliding the sealing lid over the apparatus connecting rods in alignment to the apparatus base. The diameter of each apparatus connecting rod hole, both in the apparatus base and sealing lid, are close to that of the apparatus connecting rods to improve rigidity when the apparatus is in proper use. The bottom of the sealing lid has a round protrusion, a minor diameter that extends into the opening of the food can. The protrusion is concentric to the outer diameter of the sealing lid, the diameter of which is just slightly smaller than the inside diameter of the opening of the food can. A flat sealing ring is bonded to the bottom surface of the sealing lid between the outer diameter of the protrusion and the outer diameter of the sealing lid. A synthetic rubber O-ring is seated around the outside diameter of the protrusion directly below the flat sealing ring. The purpose of the O-ring is to provide a rigid fit between the sealing lid and the inside diameter of the food can, as well as to dampen any shock and vibration. This helps to preventing any loss of steam pressure. A handle is installed to the top of the apparatus sealing lid to allow ease of maneuvering the apparatus while in proper use. The apparatus sealing lid has an internally threaded orifice to allow for such devices to facilitate the release or regulation of steam pressure No specific design for a pressure release mechanism or a pressure regulator is described because the inventor is of the belief that such devices are separate patentable apparatuses.

Each apparatus connecting rod is fabricated out of strong metal material of sufficient strength and dimensions, preferably of plain carbon steel or stainless steel alloy as to provide for the stresses required for proper use of the apparatus. The bottom of each apparatus connecting rod typically has either a bolt head or is externally threaded to allow a cap type fastener attached to the end that that tends to reduce any damage that may occur to whatever surfaces the apparatus is placed upon. The top portion of each apparatus connecting rod is typically externally threaded of threads of sufficient length for each of the fastening nuts to draw the apparatus base towards the sealing lid in a clamp like manner just enough to provide for a sufficient air tight seal of the food can without the risk of the apparatus user over tightening which would cause damage to the apparatus or the food can.

The inventor intends to market the apparatus, should patent protection be provided, as a means of purifying water, preparing water based foods for consumption, a steam container to do such work as autoclaving, and a boiler for the purpose of mechanical conversion. As there are many different industry standard food can sizes, the apparatus for converting an empty food can into a pressure cooker, a container for steam pressure, or a boiler can be manufactured to whatever industry standard dimensions are appropriate. Empty food cans are in abundance in the United States of America and are used for many different purposes. This apparatus expands the potential uses of empty food cans.

The inventor would like to give recognition to Napoleon Bonaparte in his effort to bring food to soldiers through the effort of Napoleon's Challenge. The inventor strongly believes this invention is in virtue of Bonaparte's effort.

### SUMMARY

The invention is an apparatus that converts an empty food can into a pressure cooker to prepare water based foods, a container for steam pressure, or a boiler for the purpose of mechanical conversion.

### SPECIFICATION

The present invention is directed to an apparatus for converting an empty food can into a pressure cooker, a container for steam pressure, or a boiler. An empty food can is placed into the apparatus base. Water, and perhaps food, beans as an example, is placed into the empty food can. A plurality of apparatus connecting rods are individually fed into one of each apparatus connecting rod holes in bottom of the apparatus base. The apparatus connecting rods fed into the apparatus sealing lid connecting rod holes. The sealing lid is slid onto the opening of the food can. Typical fastening devices, wings nuts for example, at the sealing lid end of the apparatus connecting rods draws the sealing lid and the apparatus base towards each other in a clamp like manner which forces the sealing lid onto the open end of the food can. This action tightens the apparatus sealing lid to the opening of the food can resulting in an air tight seal. The assembled apparatus is then placed on or over a source of heat of such significance that the resulting effect causes the contents of the can to reach the boiling temperature which generates steam pressure buildup inside the food can. An internally threaded orifice in the sealing lid provides a means for some device to release or regulate steam pressure inside the food can.

### DRAWINGS

FIG. 1 is an isometric perspective view of the apparatus with a typical food can properly installed;

FIG. 2 is an exploded view of the apparatus as shown in FIG. 1;

FIG. 3 is a cross sectional view of the apparatus as shown in FIG. 1;

### DETAILED DESCRIPTION

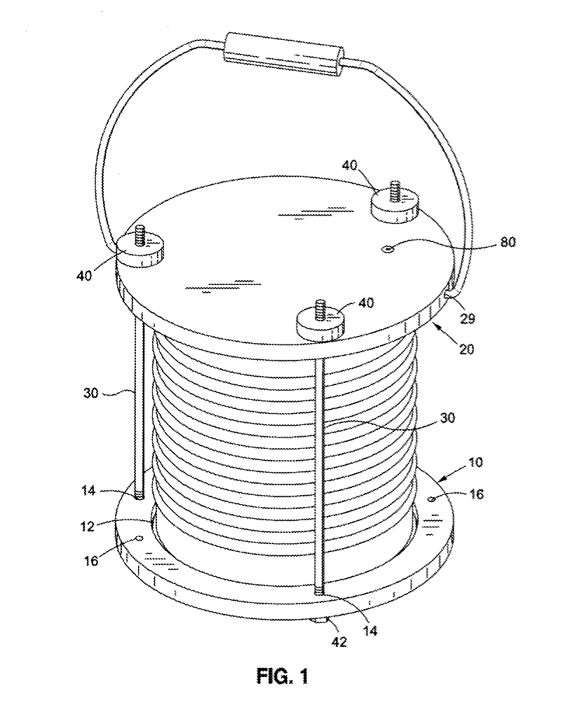

The apparatus for converting an empty food can into a pressure cooker, a container for steam pressure, or a boiler is shown in FIG. 1. It includes an apparatus base (10), a sealing lid (20), a plurality of connecting rods (30), and a threaded orifice for such a device that will release or regulate steam pressure (80). These elements are constructed and arranged to provide a means for sealing the opening of an empty food can in an air-tight manner.

Typical protective fastening devices such as cap nuts (42) are fastened to a plurality of apparatus connecting rods on the apparatus base (10) end of each apparatus connecting rod (30). One apparatus connecting rod (30) for each apparatus base connecting rod holes (14) is fed through one of each of the apparatus connecting rod holes (14) in the apparatus base (10). An empty food can is placed into the inner diameter of the apparatus base (10) until the bottom of the empty food can makes contact with the can bottom stop (12). Water or food is then placed into the empty food can. The apparatus sealing lid connecting rod holes (28) are fed over the ends of each of the apparatus connecting rods (30) protruding from the apparatus base (10). Then the apparatus sealing lid is slid onto the opening of the food can. Turning typical fastening devices, such as wing nuts (40) as an example, one for each apparatus connecting rods (30), draws the apparatus sealing lid (20) and apparatus base (10) towards each other clamping the sealing lid ring seal (24) onto the opening of the food can. This results in an airtight seal between the empty food can and the apparatus sealing lid (20). An O-ring (26) surrounds the upper portion of the apparatus sealing lid minor diameter (26) below the sealing ring (24) to provide a means of dampening lateral movement between the apparatus sealing lid minor diameter (26) and the inside of the food can. This increases rigidity and prevents loss of steam pressure due to movement between the ring seal (24) and the lip of the food can while in proper use. The apparatus is placed onto a heat source that is appropriate for the means of heating the contents of the food can to boiling temperature and allowing for the buildup of internal steam pressure. A pressure relief mechanism or a steam pressure regulator fastened to the internally threaded orifice of the sealing lid (80) provides the means of releasing or regulating steam pressure inside the food can while in proper use.

### DRAWINGS

FIG. 1 is a rough sketch of an isometric perspective view of the assembled apparatus. The apparatus base (10) has connecting rods (30) with typical nuts (42) on the apparatus base end. The apparatus sealing lid (20) has been secured to the connecting rods (30) with typical nuts (40).

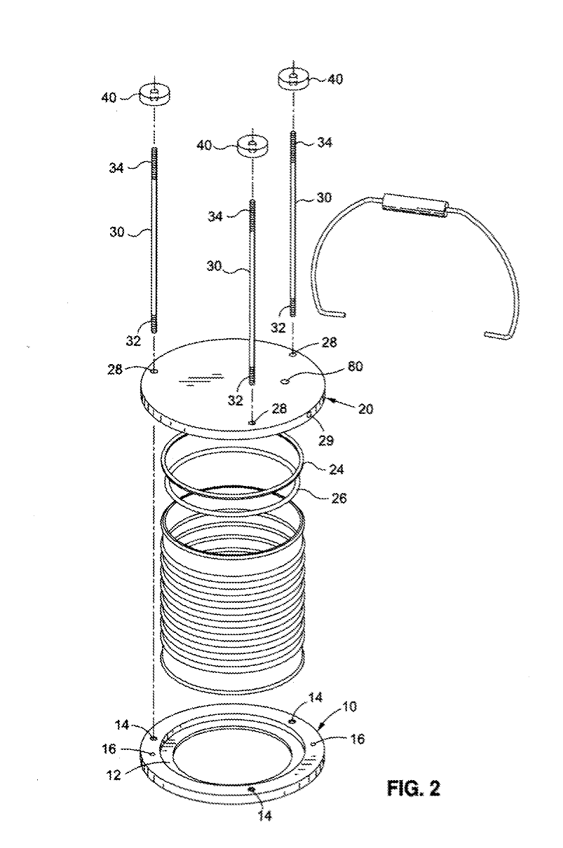

FIG. 2A and 2B is an orthographic projection of the apparatus base (10). FIG. 2A is a top view of the apparatus base (10) showing the can bottom stop (12), connecting rod holes (14), and apparatus base mounting holes (16). FIG. 2B shows a side view of the apparatus base.

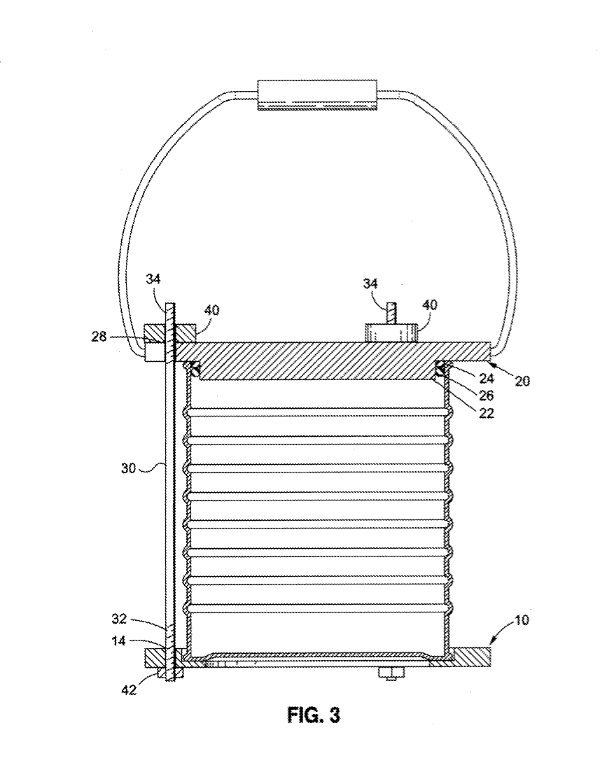

FIG. 3A and 3B is an orthographic projection of the apparatus sealing lid (20). FIG. 3A shows a top view of the apparatus sealing lid (20) with apparatus sealing lid holes (28), apparatus handle holes (29), and the sealing lid internally threaded orifice (80). FIG. 3B shows a side view of the apparatus sealing lid (20) with the minor apparatus sealing lid diameter (22), a ring seal (24), and an O-ring (26).

FIG. 4A and 4B is an orthographic projection of a typical apparatus connecting rod (30). FIG. 4A is a top view of a typical apparatus connecting rod (30). FIG. 4B is a side view of a typical apparatus connecting rod (30) with a typically threaded bottom end (32) and a typically threaded top end (34).

### REFERENCE NUMERALS

10 apparatus base
12 can bottom stop
14 apparatus base connecting rod hole
16 apparatus base mounting hole
20 apparatus sealing lid
21 apparatus sealing lid minor diameter
24 sealing ring
26 O-ring
28 apparatus sealing lid connecting rod holes
29 apparatus handle holes
30 apparatus typical connecting rod
32 typical bottom thread of apparatus connecting rod
34 typical top thread of apparatus connecting rod
40 typical fastener:
42 typical fastener:

### OPERATION

The apparatus for converting an empty food can into a pressure cooker, a container for steam pressure, or a boiler, is an apparatus. When assembled with a proper sized food can the apparatus should be used with water or water based food. Typically oil cannot be boiled for the purpose of pressure cooking and mechanical conversion. The high temperature required of oil cooking versus water shall damage the structural components of the food can rendering it useless. Hotter burning fuel, such as coal in such a thing as a hearth as an example, should

I claim:

1. An apparatus for converting an empty food can into a pressure cooker, a container for steam pressure, or a boiler which comprises;
a. An apparatus base;
b. An apparatus sealing lid with handle that contains an internally threaded orifice for such a device that can release or regulate steam pressure inside the food can when in proper use;
c. A plurality of apparatus connecting rods and such fastening hardware;

2. An apparatus as set forth in claim 1 that is assembled by feeding each of the individual apparatus connecting rods, with typical fastening hardware attached to the apparatus base end of the apparatus connecting rods, such as a cap nut, into the apparatus base connecting rod holes, one apparatus connecting rod per apparatus base connecting rod hole. Then placing an empty food can of appropriate dimensions into the inner diameter of the apparatus base until the bottom of the food can touches the apparatus base can bottom stop. Once the desired food is placed inside the empty food can, the apparatus sealing lid is applied to the food can opening. The apparatus connecting rods are fed thru the apparatus sealing lid connecting rod holes in the apparatus sealing lid and then thru the corresponding apparatus sealing base connecting rod holes. An air tight seal between the food can and the apparatus sealing lid is achieved with a clamping action by tightening a typical fastening nuts, one for each of the apparatus connecting rods;

3. An apparatus as set forth in claim 1, that after assembled as described in claim 2, is placed on or above a heat source of sufficient hotness to heat water or water based food contents of the food can to boiling temperature, thus creating the effect of a pressure cooker;

4. An apparatus as set forth in claim 1, that after assembled as described in claim 2, is placed on or above a heat source of sufficient hotness to the heat water contents of the food can to boiling temperature, generating steam pressure, allowing for such uses as an autoclave or likewise;

5. An apparatus as set forth in claim 1, that after assembled as described in claim 2, is placed on or above a heat source of sufficient hotness to the heat the water contents to boiling temperature, generating steam pressure of such force that the apparatus can be used as a boiler by attaching such devices to the apparatus sealing lid's internally threaded orifice as necessary for the purpose mechanical conversion.
